(19) United States
(12) Patent Application Publication
(10) Pub. No.: US 2026/0067189 A1
(43) Pub. Date: Mar. 5, 2026

(54) Power-On Data Collection

(71) Applicant: Arista Networks, Inc., Santa Clara, CA (US)

(72) Inventors: Geoffrey Howard Hanson, San Jose, CA (US); Charles Melvin Aden, Berkeley, CA (US); Fai Li, San Jose, CA (US)

(21) Appl. No.: 18/821,521

(22) Filed: Aug. 30, 2024

(51) Int. Cl. H04L 43/08; H04L 43/02

(52) U.S. Cl. CPC H04L 43/08; H04L 43/02

(57) ABSTRACT

A network device may include processing circuitry configured to record diagnostic data onto memory circuitry after a network device power-on event associated with a power cycle. The diagnostic data may include system console log output, hardware state information, and/or other types of diagnostic data obtained after the network device power-on event.

### BACKGROUND

A communication system can include multiple network devices that are interconnected to form a network for conveying network traffic between hosts. A network device can sometimes experience an unexpected power-off event, causing the network device to power cycle. It may be difficult for a network administrator to determine the cause of the power-off event without access to sufficient diagnostic data.

### BRIEF DESCRIPTION OF THE DRAWINGS

FIG. 1 is a diagram of an illustrative networking system having network device(s) communicatively coupled to external equipment in accordance with some embodiments.

FIG. 2 is a diagram of an illustrative network device in accordance with some embodiments.

FIG. 3 is an illustrative timing diagram of operations with respect to a network device power cycle in accordance with some embodiments.

FIG. 4 is a diagram of illustrative memory circuitry for storing diagnostic data in accordance with some embodiments.

FIG. 5 is a diagram of illustrative network device processing circuitry that records post-power-on data based on a corresponding indication in a partition of memory circuitry in accordance with some embodiments.

FIG. 6 is a diagram of an illustrative hardware processor configured to facilitate recording of post-power-on data in accordance with some embodiments.

FIG. 7 is a diagram of illustrative software-executing processing circuitry configured to execute a data recorder process that manages power-on-recording in accordance with some embodiments.

FIG. 8 is a flowchart of illustrative operations for recording network device power-on data in accordance with some embodiments.

### DETAILED DESCRIPTION

A network can convey network traffic (e.g., in the form of frames, packets, etc., and/or in other formats) between hosts or generally between devices in the network. Network devices in the network can sometimes experience unexpected power-off events, causing reboot or power cycling of the network devices to recover from the power-off events. To provide information to external equipment (e.g., operated by network administrators) that help in determining or diagnosing the cause(s) of these unexpected (or unplanned) power-off events and/or that help monitor expected power-off events (e.g., for power cycles caused by planned device updates), a network device may include memory circuitry configured to store data that persists after a network device power-off event. In such a manner, network device processing circuitry can collect device diagnostic data prior to an unexpected (or expected) power-off event for storage on the memory circuitry such that the collected data can be accessed afterwards to provide insight into the power-off event (e.g., to determine the cause of the unexpected power-off event).

In some instances (e.g., to provide insight on some types of power-off events), it may be desirable to collect diagnostic data after the network device power cycles (e.g., after the power-on event or reboot of the network device to recover from the power-off event) instead of or in addition to collecting diagnostic data prior to the power-off event. Accordingly, the processing circuitry may be configured to collect diagnostic data after the power-on event following the power-off event for storage in the memory circuitry. In one illustrative configuration described herein as an example, the memory circuitry for storing the diagnostic data may be implemented as non-volatile memory having a first partition (e.g., a first buffer) for storing diagnostic data prior to the power-off event of a power cycle and a second partition (e.g., a second buffer) for storing diagnostic data after the power-on event of the power cycle.

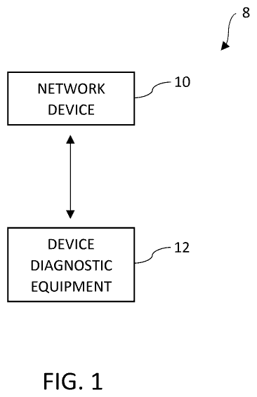

An illustrative networking system that includes one or more network devices configured to maintain diagnostic data for device power cycles, device reloads, device resets (e.g., without power cycle), and/or device reboots (e.g., in the manner described above) is shown in FIG. 1. In the example of FIG. 1, the networking system may include one or more components of a network such as network 8. Network 8 may have any suitable scope. As examples, network 8 may include, be, and/or form part of one or more local segments, one or more local subnets, one or more local area networks (LANs), one or more virtual local area networks (VLANs), one or more data center networks, one or more campus area networks, a wide area network, etc. Network 8 may include a wired network portion based on wired technologies or standards such as Ethernet (e.g., using copper cables and/or fiber optic cables) and, if desired, may include a wireless network portion such as one or more wireless local area networks (WLANs) (e.g., wireless networks compliant with the IEEE 802.11 family of standards) provided by wireless access point(s). If desired, network 8 may include internet service provider networks (e.g., the Internet) or other public service provider networks, private service provider networks (e.g., multiprotocol label switching (MPLS) networks), and/or other types of networks such as telecommunication service provider networks.

Network 8 may be implemented using and include one or more network devices that handle (e.g., process by switching, routing, forwarding, modifying, etc.) network traffic to convey information for user applications between end hosts and/or for other applications, services, and functions generally between devices (e.g., network devices and/or end host devices). Network 8 can include networking equipment forming a variety of network devices that interconnect end hosts of network 8. As examples, network devices of network 8 may include one or more wireless access points, one or more switches (e.g., single-layer (Layer 2) switches, multi-layer (Layer 2 and Layer 3) switches, etc.), one or more bridges, one or more routers, one or more gateways, one or more hubs, one or more repeaters, one or more firewalls, one or more devices serving other networking functions, one or more devices that include the functionality of two or more of these devices, and/or management equipment that manages and controls the operation of one or more of other network devices. One such network device of network 8, network device 10, is shown in the example of FIG. 1.

End hosts of network 8 may include computers, servers, portable electronic devices such as cellular telephones and laptops, other types of specialized or general-purpose host computing equipment (e.g., running one or more client-side and/or server-side applications), network-connected appliances or devices such as cameras, thermostats, wireless sensors, medical sensors, health sensors, other sensors, lighting fixtures, speakers, printers, controllers, and other network-connected equipment that serves as input-output devices and/or computing devices in a distributed networking system, devices used by network administrators (sometimes referred to as administrator devices), network service devices, and/or management equipment that manages and controls the operation of one or more of other end hosts and/or network devices. These different types of equipment and/or devices based on which hosts of network 8 are implemented may sometimes be referred to herein generally as (end) host devices.

To manage and/or monitor the operations of network 8, external equipment (external to network device 10), such as device diagnostic equipment 12, may be communicatively coupled to network device 10. As an example, equipment 12 may include administrator device(s). An illustrative administrator device may be a computing device (e.g., a laptop, a computer, etc.) operated by a network administrator (e.g., a user with administrative-level access to network 8, thereby allowing the user to access network device configuration or other information stored locally on device 10). The computing device may include processing circuitry, memory circuitry, and input-output components (e.g., wireless communication circuitry, wired communication circuitry, and/or other circuitry that provide network interfaces to facilitate connectivity with network device 10, user input-output components such as a display, a keyboard, a mouse, etc. that provide user interfaces to facilitate the reception of user input and the providing of output to the user). The computing device (e.g., network interfaces provided thereon) may be communicatively coupled to network device 10 via a direct cable connection (e.g., without other intervening network devices) or via intervening network device(s) (e.g., through one or more other network devices in network 8, through portions of network 8 such as the Internet, etc.).

As another example, equipment 12 may include a device diagnostic server (e.g., a server that provides device diagnostic tools and/or services). If desired, these tools and/or services may be provided as part of a device management server (e.g., that additionally provide other tools and/or services). The device diagnostic server may be implemented on server equipment. The server equipment may include server hardware such as one or more blade servers, one or more rack servers, and/or one or more tower servers. Compute devices and storage devices for implementing the functions of the server may be provided as part of the server hardware. The compute devices may include one or more processors or processing units based on any suitable processor architecture(s). The storage devices may include non-volatile memory, volatile memory, and/or other storage circuitry. The storage devices may include one or more non-transitory (tangible) computer-readable storage media that store the operating system software and/or any other software code. The compute devices may run (e.g., execute) an operating system and/or other software and firmware stored on the one or more non-transitory computer-readable storage media to perform the desired operations of the server (e.g., to provide the desired diagnostic tools and/or services). The server may similarly include input-output components (e.g., wireless communication circuitry, wired communication circuitry, and/or other circuitry that provide network interfaces to facilitate connectivity with network device 10).

Depending on the network configuration, equipment 12 and network device 10 may communicate with each other in any suitable manner (e.g., via different suitable communication paths). As an example, these communication paths may include network paths through a portion of network 8 (e.g., through some other network devices therein, using the Internet, etc.).

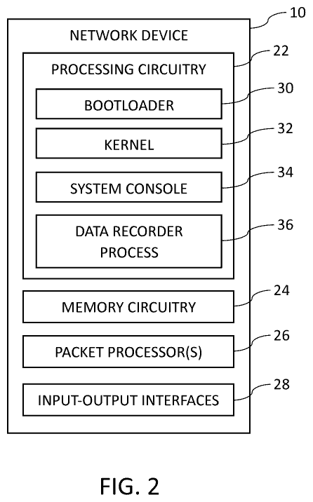

FIG. 2 is a diagram of an illustrative network device that may be used to implement any of the network devices in network 8 in FIG. 1 such as network device 10. As shown in FIG. 2, an illustrative network device 10 may include processing circuitry 22, memory circuitry 24, one or more packet processors 26, and input-output interfaces 28 (e.g., network interfaces implemented on exterior-facing ports). In one illustrative arrangement, network device 10 may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 22 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

At least a portion of processing circuitry 22 may run (e.g., execute) a network device operating system and/or other software/firmware that is stored on memory circuitry 24. Memory circuitry 24 may include one or more non-transitory (tangible) computer-readable storage media that store the operating system software and/or any other software code, sometimes referred to as program instructions, software, data, instructions, or code. In particular, memory circuitry 24 may include volatile memory (e.g., static or dynamic random-access memory), non-volatile memory (e.g., ferroelectric random-access memory, flash memory, electrically-programmable read-only memory, a solid-state drive, hard disk drive storage, etc.), removable storage devices (e.g., storage devices removably coupled to device 10), and/or other types of memory circuitry.

At least respective portions of processing circuitry 22 and memory circuitry 24 as described above may sometimes be referred to collectively as network device control circuitry (e.g., implementing a control plane of network device 10). Accordingly, processing circuitry 22 may sometimes be referred to as control plane processing circuitry and the processor(s) therein may sometimes be referred to as control plane processor(s). As just a few examples, processing circuitry 22 may execute network device control plane software such as operating system software, routing policy management software, routing protocol agents or processes, routing information base agents, and other control software, may be used to support the operation of protocol clients and/or servers (e.g., to form some or all of a communications protocol stack), may be used to support the operation of packet processor(s) 26, may store packet forwarding information, may execute packet processing software, and/or may execute other software instructions that control the functions of network device 10 and the other components therein.

Packet processor(s) 26 may be used to implement a data plane or forwarding plane of network device 10 and may therefore sometimes be referred to herein as data plane processor(s) 26 or data plane processing circuitry 26. Packet processor(s) 26 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

A packet processor 26 may receive incoming (ingress) network traffic via input-output interfaces 28, parse and analyze the received network traffic, process the network traffic based on packet forwarding decision data (e.g., in a forwarding information base) and/or in accordance with network protocol(s) or other forwarding policy, and forward (or drop) the network traffic accordingly (e.g., egress the processed network traffic via input-output interfaces 28). The packet forwarding decision data may be stored on memory circuitry integrated as part of and/or separate from packet processor 26 (e.g., on content-addressable memory), and/or on a portion of memory circuitry 24. Memory circuitry for packet processor 26 may include volatile memory, non-volatile memory, and/or other types of memory circuitry.

Input-output interfaces 28 may include one or more different types of communication interfaces such as Ethernet interfaces, optical (fiber) interfaces, and/or other types of communication interfaces for connecting network device 10 to the Internet, a local area network, a wide area network, a mobile network, and/or generally other network device(s) in network 8, peripheral devices, and computing equipment (e.g., host equipment as server equipment, host devices, etc.). In illustrative configurations described herein as an example, input-output interfaces 28 may include Ethernet interfaces implemented using and therefore include (Ethernet) ports. In particular, physical layer and/or data link layer interface circuitry in network device 10 may be coupled to the ports and use the ports to form Ethernet interfaces with the desired interface configurations.

If desired, network device 10 may include other components such as input-output devices (e.g., devices that provide user output such as a display device or one or more status lights, devices that gather user input such as one or more buttons, etc.). If desired, the other components on network device 10 may include power supply components, power management components, a system bus and/or other communication paths that couple the components of network device 10 to one another, etc. As an example, components of network device 10 may be coupled to processing circuitry 22 and/or memory circuitry 24 via one or more paths that enable the reception and transmission of control signals, data, and/or other information therebetween.

Network device 10 can sometimes experience a power cycle characterized by a network device power-off event (e.g., at which the components of network device 10 are turned off and/or are no longer supplied with power) and, following the power-off event, a network device power-on event (e.g., a reboot of the network device during which the components of network device 10 are supplied with power and/or are turned back on) in an attempt to resume normal network device networking operations (e.g., network traffic forwarding operations and/or other network traffic handling operations performed prior to the power-off event). A network device power cycle, or more specifically a network device power-off event, can be expected (e.g., during an update of device configuration, in response to a device reset based on user input, etc.) or can be unexpected (e.g., due to faulty device operations, due to faulty device components, due to unsafe device operating conditions, etc.).

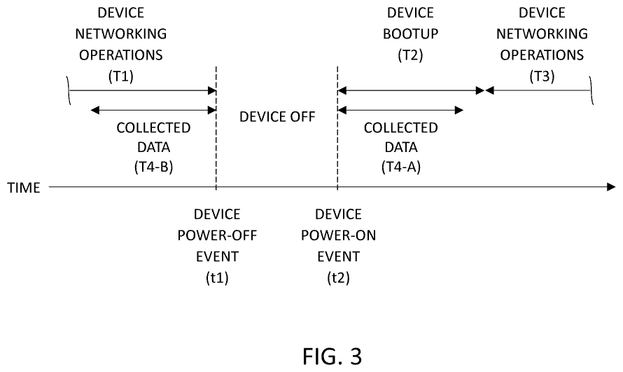

An illustrative timing diagram of different network device states and different network device operations with respect to a network device power cycle is shown in FIG. 3. In the example of FIG. 3, during time period T1, a network device such as network device 10 (FIGS. 1 and 2) may perform networking operations (e.g., forwarding and/or other handling of network traffic in network 8, executing routing protocols, providing networking features such as packet tunneling, packet sampling, etc., and/or serving other networking functions as an operating network device in network 8). Time period T1 may sometimes be referred to as an operational time period of the network device (when the network device is operable to perform networking operations).

At time t1, device 10 may experience an (unplanned) power-off event, failure event, or reset event, as part of the power cycle. As an example, the timing of the power-off event (e.g., time t1) may be unpredictable and unexpected (e.g., caused by faulty device operations, faulty device components, unsafe device operating conditions, etc.). In another scenario, the power-off event at time t1 may be planned (e.g., caused by user input, device software updates, other planned device administration operations, etc.).

Device 10 (e.g., the components therein as described in connection with FIG. 2) may remain power-off from time t1 to time t2. At time t2, device 10 (e.g., the components therein as described in connection with FIG. 2) may be supplied with power and/or is turned back on as part of the power cycle or device reboot, e.g., in an attempt recover from the device power-off event. Once power is supplied to network device components (FIG. 2) and the corresponding components are turned-on, device 10 may perform a network device bootup operation during time period T2 (which begins at time t2). This bootup operation may sometimes be referred to as a network device bootup sequence, a network device start-up operation, or a network device initialization operation. Accordingly, time period T2 may sometimes be referred to as a bootup time period of the network device, during which the network device is not yet operational for networking functions or networking operations (e.g., as performed by device 10 during time period T1). Once device 10 has successfully completed the device bootup operation, device 10 may then perform networking operations during a subsequent time period T3 (e.g., the same types of networking operations as described in connection with time period T1).

Network device state information (e.g., software state information, software error information, hardware state information, hardware fault information, sensor output information, etc., for applicable components of the network device) may be generated and provided by device 10 as device 10 operates (e.g., during time periods T1, T2, and T3). This information may serve as diagnostic data, or generally contextual data, for providing context (e.g., the conditions under which) device power cycling has occurred, and is thereby useful in determining the cause of the device power cycling. Accordingly, device 10 may be configured to record (e.g., collect and store) the diagnostic data in a manner that facilitates access by external equipment (e.g., equipment 12 in FIG. 1) at a later time, e.g., for use in determining the cause of the device power cycling.

In illustrative configurations described as an example, network device 10 (e.g., processing circuitry 22 therein) may be configured to collect and store diagnostic data during time period T4-A that overlaps (e.g., temporally overlaps) device bootup time period T2 (e.g., overlaps a beginning portion of time period T2). In this example, time period T4-A may be a time period starting at (e.g., shortly after) the device power-on event (e.g., at time t2) and ending at a time within time period T2. If desired, time period T4-A may overlap a latter or ending portion of time period T2, may overlap an entirety of time period T2, and/or may extend into and overlap a portion of time period T3, as additional examples. Data collected and stored during time period T4-A may sometimes be referred to as post-power-on data (i.e., data collected after the power-on-event) and the operations for collecting and storing post-power-on data may sometimes be referred to as post-power-on-recording, or simply power-on-recording.

The post-power-on data may be helpful as diagnostic data for the power-off event because the device boot operation may perform a device reboot that attempts to recover from or fix any errors or faults that caused the power-off event and power cycle and the steps of the device reboot may indicate the errors or faults. More generally, the post-power-on data may provide device state information upon device startup (e.g., containing remnants of the device state prior to the power-off event), which may also provide indications of the context for the power-off event.

If desired, network device 10 (e.g., processing circuitry 22 therein) may also be configured to collect and store diagnostic data during time period T4-B that overlaps (e.g., temporally overlaps) the prior device operational time period T1 (e.g., overlaps an ending portion of time period T1). Accordingly, time period T4-B may be a time period starting at a time within time period T1 and ending at the device power-off event (e.g., at time t1). Data collected and stored during time period T4-B may sometimes be referred to as pre-power-off data (i.e., data collected prior to the power-off-event) and the operations for collecting and storing pre-power-off data may sometimes be referred to as pre-power-off-recording. In some illustrative configuration described herein as an example, recording of diagnostic data may occur continuously during each device operational time period (e.g., time period T1, T3, etc.) but only a final portion of the recorded diagnostic data (e.g., the portion of data collected during time period T4-B) is preserved across the power cycle. This final portion of diagnostic data ending at the power-off event may be the most useful in determining cause(s) of the power-off event or generally providing context for the power-off event.

During time period T2, device 10 may perform a number of operations as part of the device bootup operation to boot the components of device 10 to an operational state, in which the device components are ready to perform the networking operations as described in connection with time period T3. At least some of these illustrative operations for device bootup during time period T2 may be performed by processing circuitry 22 (FIG. 2).

Referring back to FIG. 2, as part of device start-up (e.g., during time period T2 in FIG. 3), processing circuitry 22 may execute a bootloader 30, a kernel 32, a BIOS (Basic Input/Output System) and/or other firmware, and other device initialization process(es). When these different types of software (including firmware) are executed by processing circuitry 22, they can provide output indicative of the statuses of their operations as they are performed. This output may be logged by a system console 34 implemented by (e.g., executing on) processing circuitry 22 and provided as console output (e.g., console log output).

In illustrative configurations described herein as an example, the diagnostic data collected and stored during time period T4-A may include output from system console 34 (e.g., console log output indicative of activities performed by software such as a BIOS, bootloader 30, kernel 32, and/or initialization processes, and with corresponding timestamps or other timing information corresponding to the activities). As an example, some of activities performed by software may include error or fault checking activities by software (e.g., firmware), and accordingly, the collected data may include machine check exception errors logged by firmware (e.g., displayed as console output during device bootup), hardware fault information or other diagnostic data indicative of detection of failed hardware (e.g., displayed as console output during device bootup), etc. In general, any activities performed by software may be logged and displayed as console output during device bootup.

In an analogous manner, the diagnostic data collected during time period T4-B may also include output from system console 34 (e.g., console log output indicative of activities performed by software executing on processing circuitry 22). For pre-power-off data collected during time period T4-B, console log output may be indicative of activities performed by software as part of device networking operations (e.g., instead of operations associated with device bootup).

To manage the recording of data (e.g., post-power-on data and/or pre-power-off data), processing circuitry 22 may include one or more processors (e.g., a central processing unit) configured to execute (software) instructions for implementing a data recorder process 36, sometimes referred to as data recorder agent 36 (e.g., that manages the timing of diagnostic data recordation). If desired, processing circuitry 22 may, additionally or alternatively, include hardware processor(s) (e.g., a programmable logic device) configured to perform dedicated functions (e.g., dedicated functions of obtaining diagnostic data and writing the diagnostic data into storage).

In general, processing circuitry 22 may be implemented, organized, and/or configured in any suitable manner to perform each part of the data recording operations described herein (e.g., the recording of post-power-on data and/or pre-power-off data, the management of the recording, etc.). Accordingly, processing circuitry 22 may include any number of software-executing processors that execute any number of processes or agents instead of or in addition to process 36 and/or may include any number of hardware processors configured to perform any number of dedicated functions to perform the data recording operations. Accordingly, processing circuitry 22 may sometimes be described herein to perform these operations instead of specifically referring to one or more hardware processors, and/or one or more software-executing processors and the one or more agents, processes, and/or kernel executed and implemented thereon.

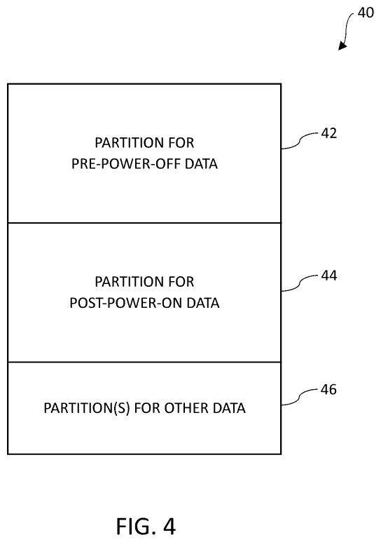

Configuration in which the data obtained during time period T4-A and/or during time period T4-B in FIG. 3 is stored on network device memory circuitry in a manner such that the stored content persists through device power cycle(s) are sometimes described herein as an example. FIG. 4 is a diagram of illustrative memory circuitry such as memory circuitry 40 (e.g., forming a part of memory circuitry 24 in FIG. 2). As an illustrative example, memory circuitry 40 may be non-volatile memory circuitry such as ferroelectric random-access memory. This example is merely illustrative. If desired, memory circuitry 40 may be volatile memory circuitry (e.g., static random-access memory) powered by a power source separate from other components of device 10 such that memory circuitry 40 remains powered even when other components of device 10 are powered off. In other scenarios (e.g., when pre-power-off data is not stored in memory circuitry 40 and/or memory circuitry 40 does not need to store content through device power cycle(s)), memory circuitry 40 may be implemented using volatile memory circuitry. It may be desirable to implement memory circuitry 40 with types of memory (e.g., ferroelectric random-access memory) that support a large number of write/overwrite cycles (e.g., greater than a million write/overwrite cycles, greater than ten million write/overwrite cycles, etc.) as processing circuitry 22 may be writing to memory circuitry 40 continuously over the lifetime of memory circuitry 40.

In the example of FIG. 4, memory circuitry 40 may be partitioned to form multiple storage regions (e.g., multiple buffers). In particular, memory circuitry 40 may include a partition 42 for storing pre-power-off data recorded (e.g., collected and stored) during time period T4-B in FIG. 3 (e.g., for storing console log output during time period T4-B). To ensure that data immediately prior to the network device power-off event is stored (e.g., data during time period T4-B is stored), partition 42 may be configured to form a circular buffer. Processing circuitry 22 may continually store data into the circular buffer during time period T1 (FIG. 3), stopping when the power-off event occurs. In such a manner, the circular buffer preserves only a fixed amount of data equal to the size of the circular buffer that corresponds to data recorded during time period T4-B (because any extra recorded data prior to time period T4-B would have been overwritten by the data recorded during time period T4-B).

Memory circuitry 40 may include a partition 44 for storing post-power-on data recorded during time period T4-A in FIG. 3. The stored post-power-on data may include device bootup information that may be indicative of causes of the power-off event causing this (re)boot, may include network device state information preserved across the power cycle, and/or may generally provide a record of diagnostic data accessible to external equipment (e.g., equipment 12 in FIG. 1) at a later time, e.g., for use (in combination with pre-power-off data in partition 42) in gaining insight into the power-off event.

In some illustrative configurations described herein as an example, partitions 42 and 44 may store console log output (e.g., encoded text output) containing logged information from software and indicative of activities performed by software (e.g., a BIOS, bootloader 30, kernel 32, and/or processes executing on processing circuitry 22). If desired, network device state information and/or other types of diagnostic data accessible during time periods T4-A and T4-B may be recorded in partitions 44 and 42, respectively.

If desired, memory circuitry 40 may include additional partition(s) 46 for storing other data such as values and codes indicative of software, hardware, and/or generally system faults (e.g., error codes such as hardware component error codes), indicative of software, hardware, and/or generally system states (e.g., register values, power supply output values, sensor measurements from temperature sensors, voltage, current, or power sensors, etc.), and/or generally indicative of causes of (unexpected) power-off events. If desired, two separate partitions 46 may be provided in memory circuitry 40 for storing these types of data obtained before the power-off event (e.g., obtained during time period T4-B in FIG. 3) and these types of data obtained after the power-on event (e.g., obtained during time period T4-A in FIG. 3).

If desired, partitions 42, 44, and 46 of memory circuitry 40 may each include multiple separate (non-contiguous) parts of a memory or may be formed from contiguous parts of a memory. If desired, memory circuitry 40 may include multiple discrete memory devices (e.g., multiple ferroelectric random-access memory devices) each of which, or combinations of which, may be used to implement a corresponding partition or multiple of partitions 42, 44, and 46.

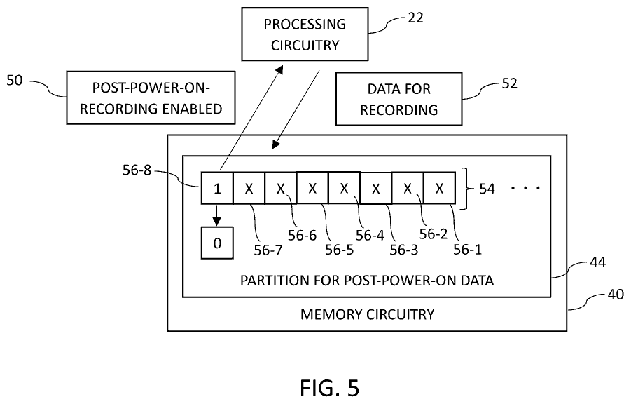

FIG. 5 is a diagram showing illustrative network device processing circuitry such as processing circuitry 22 (FIG. 2) configured to perform recording of post-power-on data. In particular, the operations described in connection with FIG. 5 may occur during time period T4-A in FIG. 3.

In the example of FIG. 5, processing circuitry 22 may obtain an indication 50 that post-power-on-recording is enabled. Based on indication 50, processing circuitry 22 may begin obtaining (e.g., collecting from one or more sources) diagnostic data 52 and writing the obtained data 52 into partition 44, thereby recording post-power-on data into memory circuitry 40. As examples, data 52 written by processing circuitry 22 into partition 44 may include console log output, software state information including software error information, hardware state information including hardware fault information, sensor output such as temperature sensor output, power supply output, and/or other device information accessible as part of device bootup during time period T4-A (FIG. 3).

In illustrative configurations described herein as an example, indication 50 of post-power-on recording being enabled may be provided in an initial state of partition 44 (e.g., prior to any data 52 being written into partition 44 after the power-on event at time t2 in FIG. 3). As shown in FIG. 5, partition 44 may be configured to store a number of bytes of data, one of which is byte 54. Byte 54 may include bits at bit locations 56-1, 56-2, 56-3, 56-4, 56-5, 56-6, 56-7, and 56-8, with the bit at bit location 56-8 being the most significant bit and the bit at bit location 56-1 being the least significant bit. The bit stored at bit location 56-8 may provide indication(s) indicative of whether or not post-power-on-recording is enabled and may therefore be referred to sometimes as a power-on-recording-enabled bit. In other words, the bit at bit location 56-8 having a first value (e.g., a bit value of ‘1’) may serve as an indication 50 that post-power-on-recording is enabled, while the bit at bit location 56-8 having a second value (e.g., a bit value of ‘0’) may serve as an indication of post-power-on-recording being disabled.

In an initial state of partition 44 prior to data 52 being written into partition 44, the bit at bit location 56-8 may have the first value indicative of post-power-on-recording being enabled. This bit may have been set (to the first value) by processing circuitry 22 prior to the power-off event at time t1 (FIG. 3) in preparation for post-power-on-recording after the power-on event at time t2 (FIG. 3).

Indication 50 may be stored in partition 44 (e.g., at bit location 56-8 in byte 54) to facilitate its automatic overwriting when data 52 is recorded in partition 44. In some illustrative configurations described herein as an example, data 52 may be and/or may be stored (e.g., encoded for storage) in the form of ASCII (American Standard Code for Information Interchange) characters. Each valid ASCII character may fit in a given byte such as byte 54 but may have a value of ‘0’ at the most significant bit location 56-8. Accordingly, when the bit at bit location 56-8 of byte 54 initially has a value of ‘1’ indicating that post-power-on-recording is enabled, the bit at bit location 56-8 is guaranteed to be updated to a value of ‘0’ after any data (e.g., in the form of an ASCII character) is written into byte 54. In other words, the bit at bit location 56-8 may also serve as an indication of whether partition 44 stores any recorded data (e.g., when the bit at bit location 56-8 has a value of ‘0’). By using the bit at location 56-8, operation(s) to update or otherwise manage separate indication(s) of whether or not post-power-on recording is enabled and/or separate indication(s) whether or not partition 44 stores recorded data can be omitted.

Advantageously, in the event of multiple power cycles, the mechanism described above in which the bit at bit location 56-8 is used to indicate that post-power-on recording being enabled (for the first of the multiple power cycles) and to indicate that post-power-on data (for the first of the multiple power cycles) has been recorded into partition 44, enables the recorded data for the first power cycle (e.g., the most relevant data for determining the cause of the multiple power cycles) to be preserved even after all of the multiple power cycles. In other words, for subsequent power cycle(s) after post-power-on-data for the first power cycle has already been recorded, processing circuitry 22 may obtain the bit at bit location 56-8 which will indicate that post-power-on recording is disabled for the subsequent power cycle(s) because the recording of post-power-on data for the prior (first) power cycle has overwritten the bit at bit location 56-8 (and the post-power-on recording was not re-enabled due to the multiple power cycles occurring in short succession).

As one illustrative example, byte 54 may be a first byte in partition 44 (e.g., the first byte location to be written into when any data 52 is written into partition 44). If desired, byte 54 may be another (later) byte in partition 44.

While configurations in which indication 50 is in a bit value at a most significant bit location of a given byte in partition 44 are sometimes described herein as an illustrative example, this example is merely illustrative. If desired, indication 50 may be stored elsewhere (e.g., at another bit location of partition 44, outside of partition 44 but in memory circuitry 40, outside of memory circuitry 40, etc.). Processing circuitry 22 may still access indication 50 (when stored elsewhere) to determine whether data 52 (obtained after the network device power-on event) should be recorded into partition 44 as post-power-on data. As additional examples, indication 50 may be any character that does not occur in console log such as BACKSPACE (e.g., binary value “00001000”), VERTICAL TAB (e.g., binary value “00001011”), NAK (e.g., binary value “00010101”), etc.

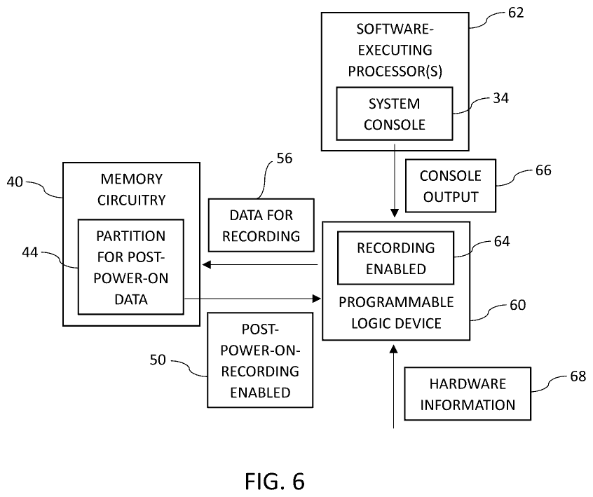

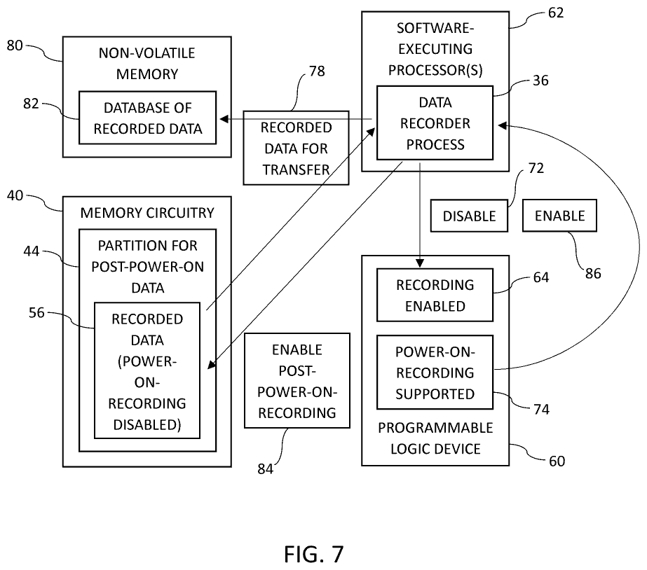

FIGS. 6 and 7 are diagrams of illustrative network device processing circuitry configured to perform and/or generally facilitate the recording of post-power-on data. In the examples of FIGS. 6 and 7, processing circuitry 22 may include a hardware processor such as a programmable logic device (PLD) 60 (e.g., a programmable array logic (PAL) device, a complex programmable logic device (CPLD), a field-programmable gate array (FPGA) device, etc.), which is sometimes referred to as processing circuitry 60, and one or more software-executing processor(s) 62 (e.g., a central processing unit), which is sometimes referred to as processing circuitry 62. This implementation of processing circuitry 22 (containing at least first processing circuitry 60 and second processing circuitry 62) is merely illustrative. As similarly described above in connection with FIG. 2, processing circuitry 22 may be configured in other manners to perform the operations described in connection with FIGS. 6 and 7 (e.g., include different numbers and/or types of processors each configured to perform one or more operations described in connection with FIGS. 6 and 7).

As shown in FIG. 6, programmable logic device 60 may be configured to (e.g., programmed to) obtain indication 50 to determine that post-power-on-recording is enabled. As an example, programmable logic device 60 may obtain indication 50 by accessing a bit within partition 44 (e.g., at bit location 56-8 as described in connection with FIG. 5).

Before obtaining indication 50, programmable logic device 60 may first receive power (along with processor(s) 62) at the network device power-on event (e.g., at time t2 in FIG. 3).

After being powered on, programmable logic device 60 may determine that (diagnostic) data recording in general is enabled and should be performed by programmable logic device 60, based on local state information (e.g., based on an indication 64 stored on programmable logic device 60, or more specifically, stored on storage circuitry associated with programmable logic device 60). As an example, upon network device bootup, programmable logic device 60 may be loaded with state information containing indication 64, e.g., as a register value or as other state information maintained by programmable logic device 60. Based on indication 64 that data recording should be performed, programmable logic device 60 may subsequently access partition 44 to obtain indication 50.

Responsive to indication 50 indicating that post-power-on-recording is enabled, programmable logic device 60 may begin obtaining (e.g., gathering, collecting, etc.) data 56 from one or more sources and providing the obtained data 56 to memory circuitry 40 for storage (e.g., write the obtained data 56 into partition 44 and/or partition(s) 46 in FIG. 4). This may define the start of time period T4-A in FIG. 3 for post-power-on data recording.

Data 56 (e.g., console output 66, hardware information 68, and/or other types of data for post-power-on-recording) may be obtained by programmable logic device 60 from different sources depending on the desired type of data and the network device configuration. As an example, after processor(s) 62 are powered on, processor(s) 62 may perform a device bootup operation (e.g., by executing bootloader 30, kernel 32, a BIOS, one or more device initialization processes, and/or other software). During this device bootup operation, the corresponding software may provide details on the operations (e.g., activities) being performed and timestamps for performing these operations, any relevant state and/or fault information, and/or other operational data in connection with the software being executed. These details may be logged and provided as console (log) output 66 from system console 34 (e.g., providing an output interface for the software executed by processor(s) 62). Programmable logic device 60 may obtain console output 66 containing device bootup information and provide console output 66 to memory circuitry 40 for storage as data 56 (e.g., write console output 66 into partition 44).

In general, programmable logic device 60 may be configured to obtain data from any suitable components of device 10 during bootup time period T2 (FIG. 3) and provide the data to memory circuitry 40 for storage (e.g., write the data into partition 44 and/or partition(s) 46 in FIG. 4). As an example, if desired, programmable logic device 60 may obtain hardware information 68 (e.g., state information and/or fault information of hardware components of device 10) for storage in memory circuitry 40 (e.g., write hardware information 68 into memory circuitry 40). Hardware information 68 may be obtained from processing circuitry 22 (e.g., processor(s) 62) executing a hardware initialization process or initializing hardware drivers, may be obtained directly from the hardware (e.g., power supply circuitry, power management circuitry, power sensors, temperatures sensors, etc.), and/or may be obtained in other manners.

Hardware information 68 may provide the state of these components in device 10 as obtained during the device bootup operation. As an example, hardware state information 68 may include hardware error codes (e.g., indicative of errors determined by processor(s) 62 during the device startup operation). These types of hardware state information (e.g., hardware error codes) may be stored in partition 44 (FIG. 4) of memory circuitry 40 or elsewhere in memory circuitry 40.

By using a hardware-based programmable logic device 60 (instead of a software-executing processor) to control the writing of post-power-on data into memory circuitry 40, the data recording process is more robust (e.g., is resilient against software-based errors, e.g., that might have caused the prior power-off event).

The collection of diagnostic data 56 for recordation and the writing of the collected data 56 into memory circuitry 40 by programmable logic device 60 may continue until partition 44 is full or until processing circuitry 22 (e.g., processor(s) 62) stops this recording of data 56 by programmable logic device 60. FIG. 7 is a diagram of illustrative network device processing circuitry configured to manage the recording of post-power-on data. These operations described in connection with FIG. 7 may follow the operations described in connection with FIG. 6.

In the example of FIG. 7, processor(s) 62 may execute a data recorder process 36 that manages the data recording operation performed by programmable logic device 60. In particular, data recorder process 36 may be initialized by processor(s) 62 at a later stage of the device bootup operation (e.g., after bootloader 30 has been initialized, after kernel 32 has been initialized and is functional, after any other initial bootup processes have been initialized and are operational, etc.). Upon initialization of data recorder process 36, processor(s) 62 (e.g., when executing process 36) may send an instruction 72 to programmable logic device 60 to stop post-power-on-recording. In particular, instruction 72 may update an indication 64 of recording being enabled to an indication of recording being disabled (e.g., by toggling a recording-enabled bit stored as local state information for programmable logic device 60). Responsive to the indication of recording being disabled, programmable logic device 60 may stop the recording of post-power-on data (e.g., may stop collecting and writing data into partition 44 as described in connection with FIG. 6). This may define the end of time period T4-A (FIG. 3) for post-power-on data recording.

In other instances, the end of time period T4-A for post-power-on data recording may be defined by the state of the partition holding post-power-on data being full (e.g., partition 44 in FIG. 4 is completely filled with data recorded during this time period T4-A). Accordingly, in these instances, the duration of time period T4-A is based on the size of partition 44 and the speed at which post-power-on data is recorded.

After the desired post-power-on data has been collected and stored in memory 40, processor(s) 62 (e.g., when executing process 36) may facilitate the transfer of the recorded post-power-on data to another location (e.g., to be stored as part of a set of records relating to previous power cycles that may be more readily accessible by components on device 10 and/or by external equipment such as equipment 12 in FIG. 1). Prior to the transfer, processor(s) 62 may obtain indication 74 (e.g., local state information such as a register value maintained by programmable logic device 60) indicative of whether or not post-power-on-recording is supported.

Based on power-on-recording not being supported, processor(s) 62 may interpret recorded data stored on memory circuitry 40 using a first format (e.g., a format that includes a partition 42 for pre-power-off data and partition(s) 46 for other data, but omits a partition 44 for post-power-on data). Based on power-on-recording being supported, processor(s) 62 may interpret recorded data stored on memory circuitry 40 using a second format (e.g., a format that includes a partition 42 for recorded pre-power-off data, a partition 44 for post-power-on data, and partition(s) 46 for other data).

Processor(s) 62 (e.g., when executing process 36) may read recorded data in memory circuitry 40 and write (a copy of) the read data into additional memory circuitry such as non-volatile memory 80 (e.g., forming a portion of memory circuitry 24 in FIG. 2), thereby transferring (e.g., copying) data 78 (e.g., some or all of data 56 and/or some or all of data in other partitions of memory circuitry 40) from memory circuitry 40 to additional memory circuitry 80. In particular, memory circuitry 80 may maintain a database 82 of recorded data files associated with different power cycles (e.g., different pre-power-off data files and/or different post-power-on data files providing context for different power-off events). The transferred data 78 may be stored as one or more data files in database 82. As an example, data 78 from each partition of memory 40 may be stored as a separate file in database 82 (e.g., a pre-power-off data file based on data from partition 42, a post-power-on data file based on data from partition 44, etc.). If desired, transferred data 78 may be stored in any other suitable format.

By storing and maintaining the partition data as files in database 82 over time, database 82 may maintain a history of files relating to each power-on and/or power-off event (e.g., a pre-power-off data file and a post-power-on data file for each power cycle). Accordingly, at a later time, the post-power-on data file and/or pre-power off data file may be accessed by other components of network device 10, by an administrator device (e.g., via a command line interface), by external equipment (e.g., equipment 12) external to network device 10, etc., and may assist in debugging operations for the corresponding power cycle (e.g., may help a network administrator in determining the cause of the power cycle).

After copying recorded data 78 from memory circuitry 40 to memory circuitry 80, processor(s) 62 (e.g., when executing process 36) may send an instruction 84 to (re-)enable post-power-on-recording for a subsequent power-on event. As an example described using the example in FIG. 5, instruction 84 may cause bit 56-8 (FIG. 5) to update its bit value from the second value (e.g., a value of ‘0’, corresponding to recorded data being present in byte 54) back to the first value (e.g., a value of ‘1’ indicating that post-power-on-recording is enabled).

If desired, after processor(s) 62 copy recorded data 78 from memory circuitry 40 to memory circuitry 80 or at another suitable time (e.g., prior to initialization of process 36), programmable logic device 60 may read the values and codes stored in memory circuitry 40 (e.g., in partition(s) 46) and store them in its local storage device (e.g., registers) such that they are accessible by other components of network device 10, by an administrator device (e.g., via a command line interface), by external equipment (e.g., equipment 12) external to network device 10, etc.

In illustrative configurations in which memory circuitry 40 is configured to store pre-power-off data (e.g., in partition 42 in FIG. 4), processor(s) 62 (e.g., when executing process 36) may send an instruction 86 to programmable logic device to re-enable data recording as indicated by indication 64. This may cause programmable logic device 60 to begin collecting diagnostic data and writing the diagnostic data into partition 42 (e.g., configured as a circular buffer) to provide pre-power-off data for a subsequent power-off event.

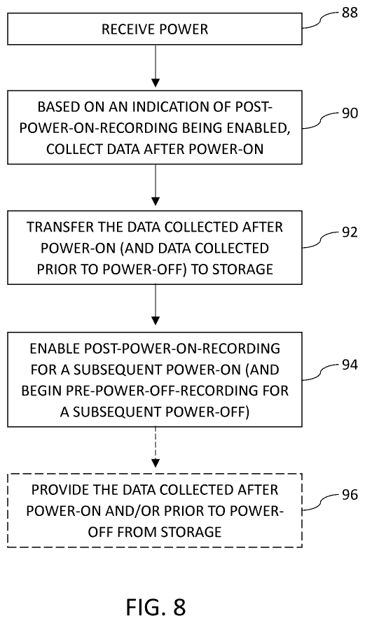

FIG. 8 is a flowchart of illustrative operations for recording network device post-power-on data. In particular, these operations may be performed by one or more processors of network device 10 (e.g., processing circuitry 22 in FIG. 2, processing circuitry 60 and processing circuitry 62 in the examples of FIGS. 6 and 7) using other components of network device 10 (e.g., memory circuitry 24, interfaces 28, etc., in FIG. 2). In some configurations described herein as an illustrative example, at least some of the operations described in connection with FIG. 6 may be performed by the one or more processors by executing software instructions stored on memory circuitry (e.g., one or more non-transitory computer-readable storage media). If desired, one or more operations described in connection with FIG. 6 may be performed by and/or using dedicated hardware processors (e.g., programmable logic devices) and/or other components in network device 10.

At block 88, network device processing circuitry (e.g., processing circuitry 22) may receive power. As an example, the processing circuitry may receive power as part of a network device power-on event following a network device power-off event, thereby defining a network device power cycle. After receiving power, the processing circuitry (e.g., software-executing processor(s)) may perform a network device bootup operation. If desired, the processing circuitry may perform the operations at block 88 by performing at least some of the operations described in connection with FIG. 6.

At block 90, the processing circuitry (e.g., a hardware processor such as a programmable logic device) may obtain an indication of whether or not post-power-on-recording is enabled.

Based on post-power-on-recording being enabled, the processing circuitry (e.g., the hardware processor) may collect data (e.g., diagnostic data such as console log output) after the network device is powered on and write the collected data into first memory circuitry such as ferroelectric random-access memory (e.g., into one or more partitions of the first memory circuitry). At a suitable time, the processing circuitry may stop post-power-on-recording. If desired, the processing circuitry may perform the operations at block 90 by performing at least some of the operations described in connection with FIGS. 6 and 7.

At block 92, the processing circuitry (e.g., the software-executing processor(s)) may transfer the post-power-on data collected after the network device is powered-on and optionally pre-power-off data collected prior to the network device being powered off to storage in second memory circuitry (from the first memory circuitry). This transfer may help free up the first memory circuitry to record additional pre-power-off data and/or post-power-on data for a subsequent network device power cycle. If desired, the processing circuitry may perform the operations at block 92 by performing at least some of the operations described in connection with FIG. 7.

At block 94, the processing circuitry (e.g., the software-executing processor(s)) may (re-)enable post-power-on-recording for a subsequent power-on event and optionally begin pre-power-off-recording for a subsequent power-off event. If desired, the processing circuitry may perform the operations at block 94 by performing at least some of the operations described in connection with FIG. 7.

At block 96, which can occur at any suitable time and/or based on one or more criteria being met, the processing circuitry may provide (e.g., output) the post-power-on data and optionally the pre-power-off data in storage on the second memory circuitry to a requesting entity (e.g., an entity internal to the processing circuitry such as a software process used to analyze or otherwise process the collected data, an entity external to the processing circuitry such as a hardware component on the network device, an entity external to the network device such as external diagnostic equipment 12 in FIG. 1, etc.). If desired, the processing circuitry may perform the operations at block 96 by performing at least some of the operations described in connection with FIG. 7.

The methods and operations described above in connection with FIGS. 1-8 may be performed by the components of one or more network devices in network 8 (FIG. 1) and/or one or more servers or other host equipment using software, firmware, and/or hardware (e.g., dedicated circuitry or hardware). Software code for performing these operations may be stored on one or more non-transitory computer-readable storage media (e.g., tangible computer-readable storage media) stored on one or more of the components of the network device(s) and/or server(s) or other host equipment. The software code may sometimes be referred to as software, data, instructions, program instructions, or code. The one or more non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry on one or more of the components of the network device(s) and/or server(s) or other host equipment (e.g., processing circuitry of network devices, compute devices of server equipment, processing circuitry of computing devices, etc.).

The foregoing is merely illustrative and various modifications can be made to the described embodiments. The foregoing embodiments may be implemented individually or in any combination.

What is claimed is:

1. A network device comprising:
memory circuitry having a partition configured to store diagnostic data from a time period after a network device power-on event; and
processing circuitry coupled to the memory circuitry and configured to:
begin, based on an indication that power-on-recording is enabled, collecting the diagnostic data after the network device power-on event;
write the collected diagnostic data into the partition of the memory circuitry; and
stop collecting the diagnostic data at an end of the time period.

2. The network device defined in claim 1, wherein the time period is prior to any network traffic forwarding operation performed by the network device after the network device power-on event.

3. The network device defined in claim 2, wherein the time period, from which the diagnostic data is stored, overlaps a network device bootup time period prior to a network device operational time period, during which network traffic forwarding operations are performed by the network device.

4. The network device defined in claim 3, wherein the processing circuitry is configured to implement a system console that provides console log output during the network device bootup time period and wherein the collected diagnostic data comprises the console log output.

5. The network device defined in claim 4, wherein the processing circuitry is configured to execute network device initialization software during the network device bootup time period and wherein output based on the execution of the network device initialization software is provided as the console log output and is collected as the diagnostic data.

6. The network device defined in claim 5, wherein the network device initialization software comprises a bootloader and a kernel.

7. The network device defined in claim 1, wherein the indication that power-on-recording is enabled is stored in the partition of the memory circuitry and wherein the processing circuitry is configured to begin collecting the diagnostic data by accessing the indication from the partition of the memory circuitry and determining that power-on-recording is enabled based on the indication.

8. The network device defined in claim 7, wherein the processing circuitry is configured to overwrite the indication that power-on-recording is enabled with the collected diagnostic data.

9. The network device defined in claim 8 further comprising:
additional memory circuitry coupled to the processing circuitry, wherein the processing circuitry is configured to:
write, after the end of the time period, the collected diagnostic data stored in the partition of the memory circuitry into the additional memory circuitry; and
write, after the diagnostic data stored in the partition of the memory circuitry has been written into the additional memory circuitry, an indication that power-on-recording for a subsequent network device power-on event is enabled into the partition of the memory circuitry.

10. The network device defined in claim 1, wherein the partition of the memory circuitry is a first partition of the memory circuitry, wherein the memory circuitry comprises a second partition configured to store additional diagnostic data from a time period prior to a network device power-off event, and wherein the network device remains powered off between the network device power-off event and the network device power-on event.

11. The network device defined in claim 10, wherein the processing circuitry is configured to write, after the end of the time period, the collected diagnostic data stored in the first partition of the memory circuitry and the additional diagnostic data stored in the second partition of the memory circuitry into additional memory circuitry.

12. The network device defined in claim 11, wherein the second partition of the memory circuitry is configured as a circular buffer and wherein the processing circuitry is configured to begin pre-power-off-recording to the circular buffer after the diagnostic data stored in the first partition of the memory circuitry and the additional diagnostic data stored in the second partition of the memory circuitry have been written into the additional memory circuitry.

13. The network device defined in claim 10, wherein the memory circuitry comprises a third partition configured to store network device hardware state information.

14. The network device defined in claim 10, wherein the memory circuitry and the additional memory circuitry each comprise non-volatile memory.

15. The network device defined in claim 1, wherein the memory circuitry comprises ferroelectric random-access memory.

16. A network device comprising:
memory circuitry;
first processing circuitry coupled to the memory circuitry and configured to begin, after a device power-on event, writing diagnostic data into the memory circuitry; and
second processing circuitry coupled to the first processing circuitry and the memory circuitry and configured to:
control the first processing circuitry to stop the writing of the diagnostic data into the memory circuitry;
read the diagnostic data from the memory circuitry; and
write, after the diagnostic data is read from the memory circuitry, an indication that power-on recording is enabled for a subsequent device power-on event into the memory circuitry.

17. The network device defined in claim 16, wherein the diagnostic data written into the memory circuitry comprises console output provided by a system console implemented on the second processing circuitry and wherein the console output comprises information generated as part of network device initialization after the power-on event.

18. The network device defined in claim 16, wherein the first processing circuitry comprises a programmable logic device and wherein the second processing circuitry comprises one or more software-executing processors.

19. A network device comprising:
non-volatile memory circuitry having a first partition and a second partition; and
processing circuitry coupled to the non-volatile memory circuitry and configured to:
obtain first diagnostic data prior to a power-off event of a power cycle;
provide the first diagnostic data to the first partition of the non-volatile memory circuitry for storage;
obtain second diagnostic data after a power-on event of the power cycle; and
provide the second diagnostic data to the second partition of the non-volatile memory circuitry for storage.

20. The network device defined claim 19, wherein the first diagnostic data obtained prior to the power-off event and the second diagnostic data obtained after the power-on event each comprise console log output, wherein the processing circuitry is configured to provide network device hardware state information to the non-volatile memory circuitry for storage, and wherein the second diagnostic data is obtained prior to network traffic forwarding by data plane processing circuitry of the network device.
